(19) United States
(12) Patent Application Publication
(10) Pub. No.: US 2024/0248453 A1
(43) Pub. Date: Jul. 25, 2024

(54) CONTROL DEVICE FOR INDUSTRIAL MACHINE

(71) Applicant: Fanuc Corporation, Minamitsuru-gun, Yamanashi (JP)

(72) Inventor: Hideo Ogino, Minamitsuru-gun, Yamanashi (JP)

(73) Assignee: Fanuc Corporation, Minamitsuru-gun, Yamanashi (JP)

(21) Appl. No.: 18/561,417

(22) PCT Filed: May 25, 2021
(86) PCT No.: PCT/JP2021/019886

§ 371 Date: Nov. 16, 2023

(51) Int. Cl. G05B 19/409; G05B 19/416

(52) U.S. Cl. CPC G05B 19/409; G05B 19/4166; G05B 2219/39442

(57) ABSTRACT

This control device includes: a determination unit that determines whether an operation mode which has been set is a manual operation mode; an image display unit that causes a manipulation image corresponding to the manual operation mode to be displayed on a display screen, if the determination unit has determined that the operation mode is the manual operation mode; an assessment unit that assess the movement state of a drive shaft on the basis of a manipulation performed with respect to the manipulation image; and a control unit that controls the drive shaft on the basis of the movement state assessed by the assessment unit.

### CROSS REFERENCE TO RELATED APPLICATIONS

This is the U.S. National Phase application of PCT/JP2021/019886, filed May 25, 2021, the disclosure of which is incorporated herein by reference in its entirety for all purposes.

### FIELD OF THE INVENTION

The present disclosure relates to a controller for an industrial machine.

### BACKGROUND OF THE INVENTION

A control panel of a controller that controls an industrial machine is equipped with an axis selection switch, a magnification selection switch, an axis movement switch, a jog feed switch, etc. in addition to an operation mode setting switch for setting an operation mode (for example, Patent Document 1 and Patent Document 2).

### PATENT DOCUMENT

Patent Document 1: JP 2020-67956 A
Patent Document 2: JP S60-141459 A

### SUMMARY OF THE INVENTION

However, when the control panel is provided with each dedicated switch, manufacturing costs of the control panel increase.

An object of the disclosure is to provide a controller for an industrial machine that can reduce the manufacturing costs of the control panel.

A controller includes a decision unit configured to decide whether or not a set operation mode is a manual operation mode, an image display unit configured to display an operation image corresponding to the manual operation mode on a display screen when the decision unit decides that the operation mode is the manual operation mode, a determination unit configured to determine a motion mode of a driving axis based on an operation on the operation image, and a control unit configured to control the driving axis based on the motion mode determined by the determination unit.

According to one aspect of the disclosure, it is possible to reduce manufacturing costs of the control panel of the controller.

### BRIEF DESCRIPTION OF DRAWINGS

FIG. 1 is a block diagram illustrating an example of a hardware configuration of a controller;

FIG. 2 is a block diagram illustrating an example of functions of the controller;

FIG. 3 is a diagram illustrating an example of a driving axis information image;

FIG. 4 is a diagram illustrating an example of an operation mode setting switch;

FIG. 5A is a diagram for describing an example of an operation image and an axis specification image;

FIG. 5B is a diagram for describing an example of an operation on the operation image;

FIG. 5C is a diagram for describing an example of an operation on the operation image;

FIG. 5D is a diagram for describing an example of an operation on the operation image;

FIG. 6 is a flowchart illustrating an example of a flow of processing executed by the controller;

FIG. 7A is a diagram illustrating an example of the operation image and the driving axis information image;

FIG. 7B is a diagram illustrating an example of an operation on the operation image;

FIG. 7C is a diagram illustrating an example of an operation on the operation image;

FIG. 7D is a diagram illustrating an example of an operation on the operation image;

FIG. 8 is a diagram illustrating an example of the operation image;

FIG. 9 is a diagram illustrating an example of an operation on the operation image; and

FIG. 10 is a diagram illustrating another example of the operation on the operation image.

### DETAILED DESCRIPTION OF EMBODIMENTS OF THE INVENTION

An embodiment of the disclosure will be described below with reference to the drawings. Note that not all combinations of features described in the following embodiment are necessarily required to solve the problem. In addition, more detailed description than necessary may be omitted. Further, the following description of the embodiment and drawings are provided for a full understanding of the disclosure by those skilled in the art and are not intended to limit the scope of the claims.

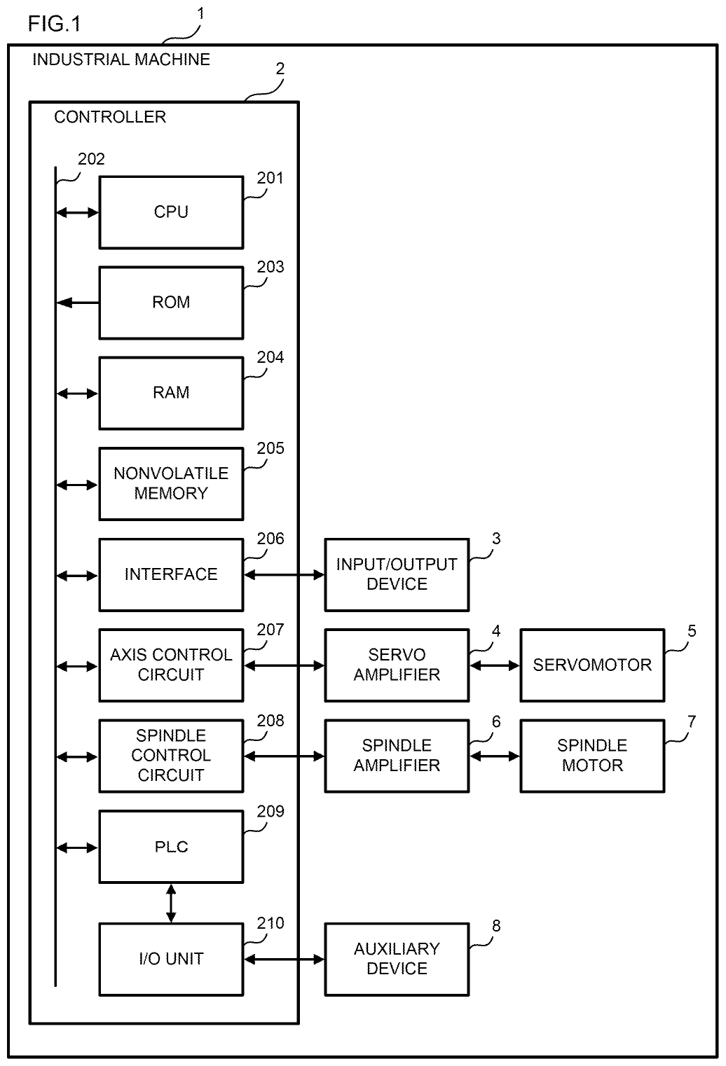

FIG. 1 is a diagram illustrating an example of a hardware configuration of an industrial machine. For example, the industrial machine 1 is a machine tool, a wire electric discharge machine, or a robot. The machine tool includes a lathe, a machining center, and a multi-tasking machine. For example, the robot is an industrial robot such as a manipulator.

The industrial machine 1 includes a controller 2, an input/output device 3, a servo amplifier 4 and a servomotor 5, a spindle amplifier 6 and a spindle motor 7, and an auxiliary device 8.

The controller 2 is a device that controls the entire industrial machine 1. The controller 2 is, for example, a numerical controller that controls the industrial machine 1. The controller 2 includes a CPU (Central Processing Unit) 201, a bus 202, a ROM (Read Only Memory) 203, a RAM (Random Access Memory) 204, and a nonvolatile memory 205.

The CPU 201 is a processor that controls the entire controller 2 according to a system program. The CPU 201 reads a system program, etc. stored in the ROM 203 via the bus 202 and performs various processes based on the system program. In addition, the CPU 201 controls the servomotor 5 and the spindle motor 7 based on a machining program.

For example, the CPU 201 analyzes the machining program and outputs control commands to the servomotor 5 and the spindle motor 7 for each control cycle.

The bus 202 is a communication path that connects respective pieces of hardware in the controller 2 to each other. The respective pieces of hardware in controller 2 exchange data via the bus 202.

The ROM 203 is a storage device that stores a system program, etc. for controlling the entire controller 2. The ROM 203 is a computer-readable storage medium.

The RAM 204 is a storage device that temporarily stores various data. The RAM 204 functions as a working area for the CPU 201 to process various data.

The nonvolatile memory 205 is a storage device that retains data even in a state in which the power of the industrial machine 1 is turned off and power is not supplied to the controller 2. The nonvolatile memory 205 stores, for example, a machining program and various parameters input from the input/output device 3. The nonvolatile memory 205 is a computer-readable storage medium. The nonvolatile memory 205 includes, for example, an SSD (Solid State Drive).

The controller 2 further includes an interface 206, an axis control circuit 207, a spindle control circuit 208, a PLC (Programmable Logic Controller) 209, and an I/O unit 210.

The interface 206 connects the bus 202 and the input/output device 3 to each other. For example, the interface 206 transmits various data processed by the CPU 201 to the input/output device 3.

The input/output device 3 is a device that receives various data via the interface 206 and displays the various data. In addition, the input/output device 3 receives input of various data and transmits the various data to the CPU 201 via the interface 206. The input/output device 3 is, for example, a touch panel. When the input/output device 3 is a touch panel, the touch panel is, for example, a capacitive-type touch panel. Note that the touch panel is not limited to the capacitive type, and may be a touch panel of another type. The input/output device 3 is attached to, for example, a control panel (not illustrated) in which the controller 2 is stored.

The axis control circuit 207 is a circuit that controls the servomotor 5. The axis control circuit 207 receives a control command from the CPU 201 and outputs a command for driving the servomotor 5 to the servo amplifier 4. For example, the axis control circuit 207 transmits a torque command for controlling torque of the servomotor 5 to the servo amplifier 4.

The servo amplifier 4 receives a command from the axis control circuit 207 and supplies current to the servomotor 5.

The servomotor 5 is driven by being supplied with current from the servo amplifier 4. For example, the servomotor 5 is coupled to a ball screw that drives a tool post. By driving the servomotor 5, for example, a structure of the industrial machine 1 such as the tool post moves in an X-axis direction, a Y-axis direction, or a Z-axis direction. Note that the servomotor 5 may incorporate a speed detector (not illustrated) that detects a feed rate of each feed axis.

The spindle control circuit 208 is a circuit for controlling the spindle motor 7. The spindle control circuit 208 receives a control command from the CPU 201 and outputs a command for driving the spindle motor 7 to the spindle amplifier 6. For example, the spindle control circuit 208 transmits a torque command for controlling torque of the spindle motor 7 to the spindle amplifier 6.

The spindle amplifier 6 receives a command from the spindle control circuit 208 and supplies current to the spindle motor 7.

The spindle motor 7 is driven by being supplied with current from the spindle amplifier 6. The spindle motor 7 is coupled to the spindle and rotates the spindle.

The PLC 209 is a device that executes a ladder program to control the auxiliary device 8. The PLC 209 transmits a command to the auxiliary device 8 via the I/O unit 210.

The I/O unit 210 is an interface that connects the PLC 209 and the auxiliary device 8 to each other. The I/O unit 210 transmits a command received from the PLC 209 to the auxiliary device 8.

The auxiliary device 8 is a device that is installed in the industrial machine 1 and performs an auxiliary operation in the industrial machine 1. The auxiliary device 8 may be a device installed around the industrial machine 1. The auxiliary device 8 operates based on a command received from the I/O unit 210. The auxiliary device 8 is, for example, a tool changer, a cutting fluid injection device, or an opening/closing door driving device. Next, an example of functions of the controller 2 will be described.

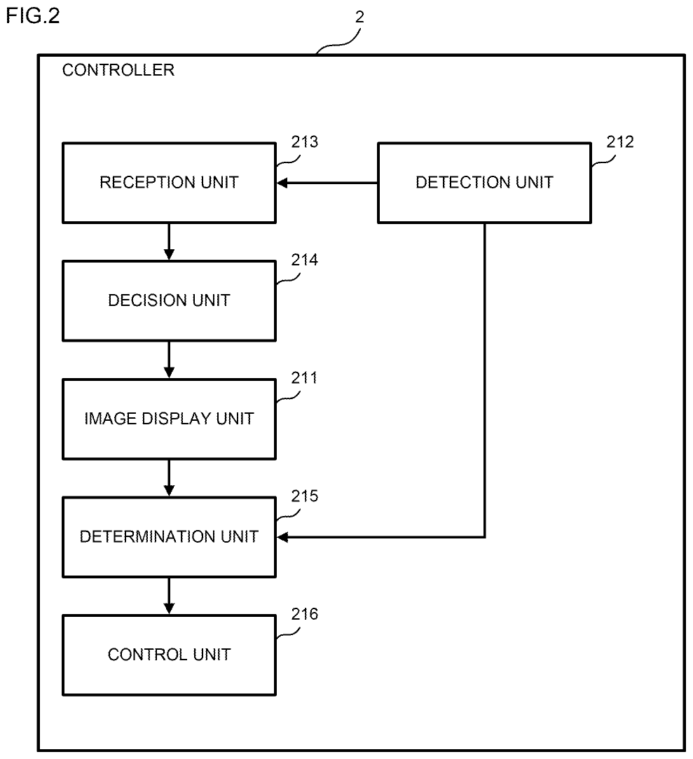

FIG. 2 is a block diagram illustrating an example of functions of the controller 2. The controller 2 includes an image display unit 211, a detection unit 212, a reception unit 213, a decision unit 214, a determination unit 215, and a control unit 216. For example, the image display unit 211, the detection unit 212, the reception unit 213, the decision unit 214, the determination unit 215, and the control unit 216 are realized by the CPU 201 performing arithmetic processing using a system program stored in the ROM 203 and various data stored in the nonvolatile memory 205.

The image display unit 211 displays a driving axis information image indicating driving axis information of a driving axis on a display screen. The driving axis information includes an axis name of a driving axis and coordinate values of each axis in a predetermined coordinate system. For example, the predetermined coordinate system is an absolute coordinate system of the industrial machine 1. The predetermined coordinate system may be a machine coordinate system of the industrial machine 1. For example, the display screen is a display screen of the input/output device 3.

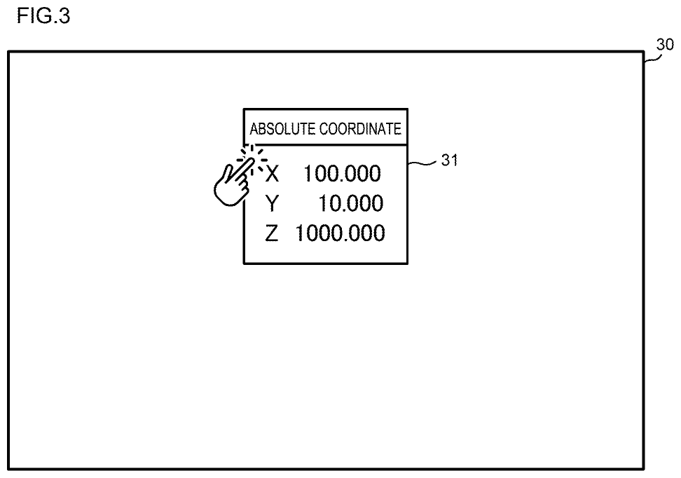

FIG. 3 is a diagram illustrating an example of the driving axis information image displayed on the display screen. A driving axis information image 31 illustrated in FIG. 3 indicates coordinate values of the X-axis, the Y-axis, and the Z-axis in the absolute coordinate system.

Incidentally, in FIG. 3, a figure simulating a hand indicates that the driving axis information image 31 is touch-operated, and is not displayed on the display screen 30. Similarly, a figure simulating a hand drawn in each figure to be described later is not displayed on the display screen 30.

The detection unit 212 detects a touch operation on the display screen 30. The detection unit 212 detects a touch operation on the driving axis information image 31. The touch operation on the driving axis information image 31 may be an operation of touching the vicinity of the driving axis information image 31 in addition to an operation of touching the driving axis information image 31.

For example, the detection unit 212 detects a touch operation on a region displaying the axis name included in the driving axis information image 31 or a region near the region. In the example illustrated in FIG. 3, the detection unit 212 detects a touch operation on a region displaying a character “X” indicating the name of the X-axis.

The touch operation includes a tap operation. In addition, the touch operation may be a long press operation or a slide operation. The tap operation may be a plurality of tap operations. The touch operation is an operation using a finger of an operator. In addition, the touch operation may be an operation using a touch pen.

The reception unit 213 receives setting of an operation mode. The operation mode means a setting state that defines a motion of the controller 2. For example, the operation mode includes an editing mode, an automatic operation mode, and a manual operation mode.

The editing mode is a mode in which the machining program is edited. The automatic operation mode is a mode in which the industrial machine 1 is automatically driven according to an instruction. The automatic operation mode includes an MDI mode, a memory mode, and a DNC mode. Note that each of these modes included in the automatic operation mode is publicly known, and thus a detailed description thereof will be omitted here.

The manual operation mode is a mode in which the industrial machine 1 is manually driven by an operation of an operator. The manual operation mode includes a jog feed mode, an incremental feed mode, and a handle feed mode.

The jog feed mode is a mode in which the driving axis is moved at a jog feed rate set by a parameter while an axis movement button is pressed. The driving axis is an axis for driving each unit of the industrial machine 1. For example, the driving axis includes feed axes such as an X-axis, a Y-axis, and a Z-axis. Furthermore, the driving axis may include rotating axes such as an A-axis, a B-axis, and a C-axis. Note that the jog feed rate can be instructed by a jog feed override.

The incremental feed mode is a mode in which the driving axis is moved at an incremental feed magnification set by a magnification selection button each time the axis movement button is pressed.

The handle feed mode is a mode in which the driving axis is moved using a pulse handle.

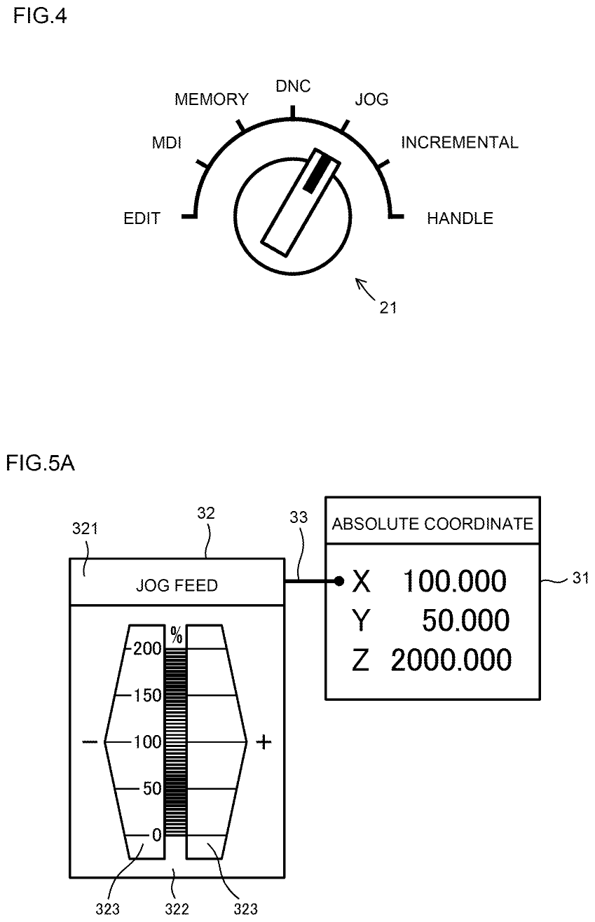

FIG. 4 is a diagram illustrating an example of the operation mode setting switch. For example, the operation mode setting switch 21 includes a rotary switch. One of the editing mode, the MDI mode, the memory mode, the DNC mode, the jog feed mode, the incremental feed mode, and the handle feed mode is selected by the operation mode setting switch 21.

The reception unit 213 receives information input from the operation mode setting switch 21. In this way, an operation mode is set.

The decision unit 214 decides whether or not the set operation mode is a manual operation mode. For example, when the operation mode received by the reception unit 213 is the jog feed mode, the incremental feed mode, or the handle feed mode, the decision unit 214 decides that the set operation mode is the manual operation mode.

When the detection unit 212 detects a touch operation on the display screen 30, the image display unit 211 displays the operation image and the axis specification image on the display screen 30. The operation image refers to an operation image for manually moving the driving axis in the manual operation mode.

For example, when the decision unit 214 decides that the operation mode is the manual operation mode, and the detection unit 212 detects a touch operation on the driving axis information image 31, the image display unit 211 displays the operation image on the display screen 30. The image display unit 211 displays an operation image corresponding to the manual operation mode on the display screen 30. That is, when the operation mode is set to the jog feed mode, the image display unit 211 displays an operation image for executing jog feed. In addition, when the operation mode is set to the incremental feed mode, the image display unit 211 displays an operation image for executing incremental feed.

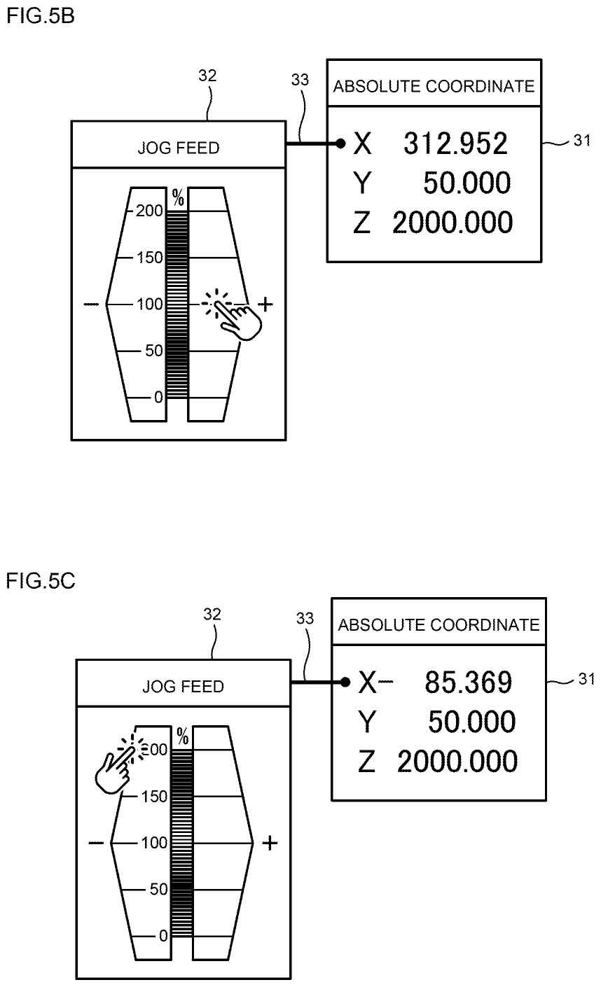

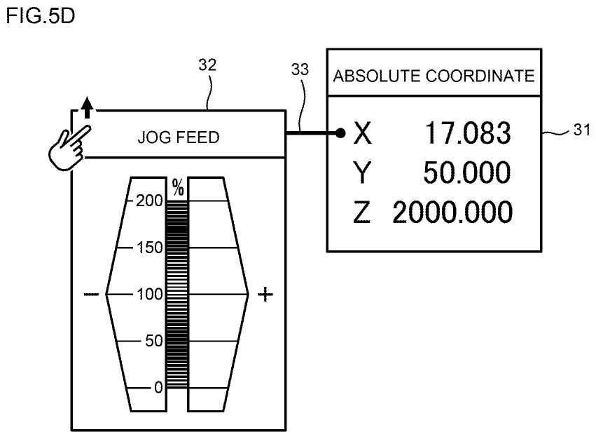

FIG. 5A is a diagram illustrating an example of the operation image and the axis specification image. FIG. 5A illustrates the operation image 32 and the axis specification image 33 displayed when the operation mode is set to the jog feed mode.

The operation image 32 is displayed adjacent to the driving axis information image 31. In other words, the image display unit 211 displays the operation image 32 and the driving axis information image 31 side by side. In this case, the operation image 32 and the driving axis information image 31 may be displayed partially overlapping each other. Alternatively, the images may be displayed so that one end of the operation image 32 and one end of the driving axis information image 31 contact each other. Alternatively, the operation image 32 and the driving axis information image 31 may be separately displayed. The operation image 32 includes a setting mode display region 321 and an operation region 322.

The setting mode display region 321 is a region in which an image indicating which operation mode among manual operation modes is set is displayed. In the example illustrated in FIG. 5A, characters “jog feed” indicating the jog feed mode are displayed in the setting mode display region 321. In this way, the operator can recognize that manual operation is performed in the jog feed mode.

The operation region 322 is a region in which an axis movement button 323 for performing a jog feed operation is displayed. A movement direction of the driving axis and a jog feed override value can be designated by the axis movement button 323. An override value is a ratio with respect to a jog feed speed value set by a parameter. For example, when the override value is 50%, the driving axis is moved at a speed of 50% of a value set by the parameter. In addition, a scale indicating the jog feed override value is displayed in the operation region 322.

The axis movement button 323 includes a pentagonal image disposed on a right side of a rectangular image and a pentagonal image disposed on a left side of the rectangular image. The axis movement button 323 disposed on the right side of the rectangular image is a button for moving the driving axis in a positive direction. In addition, the axis movement button 323 disposed on the left side of the rectangular image is a button for moving the driving axis in a negative direction.

The axis specification image 33 is an image for specifying a driving axis targeted for jog feed. In the example illustrated in FIG. 5A, the axis specification image 33 is a line segment extending leftward in a horizontal direction from a position of “X” of the driving axis information image 31. In this way, the operator can recognize that the driving axis targeted for jog feed is the X-axis.

The determination unit 215 determines a motion mode of the driving axis based on an operation on the operation image 32. The motion mode is defined by a movement direction of the driving axis and an override value. That is, the determination unit 215 determines whether to move the driving axis in a positive direction or in a negative direction, and an override value of a feed rate.

FIG. 5B is a diagram for describing an example of an operation on the operation image 32. FIG. 5B illustrates that a touch operation is performed on a position of 100% in the axis movement button 323 on the right side. In this case, the determination unit 215 determines to move the driving axis at an override value of 100% in a positive direction of the X-axis.

FIG. 5C is a diagram for describing an example of an operation on the operation image 32. FIG. 5C illustrates that a touch operation is performed on a position of 200% in the axis movement button 323 on the left side. In this case, the determination unit 215 determines to move the driving axis at an override value of 200% in a negative direction of the X-axis.

The control unit 216 controls the driving axis based on a motion mode determined by the determination unit 215. For example, while the touch operation is performed on a position indicated by a hand of FIG. 5B, the control unit 216 moves the driving axis at the override value of 100% in the positive direction of the X-axis. In addition, while the touch operation is performed on a position indicated by a hand of FIG. 5C, the control unit 216 moves the driving axis at the override value of 200% in the negative direction of the X-axis.

When an operation of eliminating the operation image 32 is performed, or when there is no operation on the operation image 32 for a predetermined time, the determination unit 215 determines to hide the operation image 32.

FIG. 5D is a diagram for describing an example of the operation on the operation image 32. For example, the elimination operation is a flick operation. In this way, the image display unit 211 eliminates the operation image 32 together with the axis specification image 33 from the display screen 30. A direction of the flick operation may be any direction. Note that the flick operation is an operation of rapidly moving a finger on the display screen 30 or an operation flicking the display screen 30. In addition, when there is no operation on the operation image 32 for, for example, 20 seconds, the determination unit 215 determines to hide the operation image 32.

Next, a description will be given of a flow of processing executed when the controller 2 controls the driving axis in the manual operation mode.

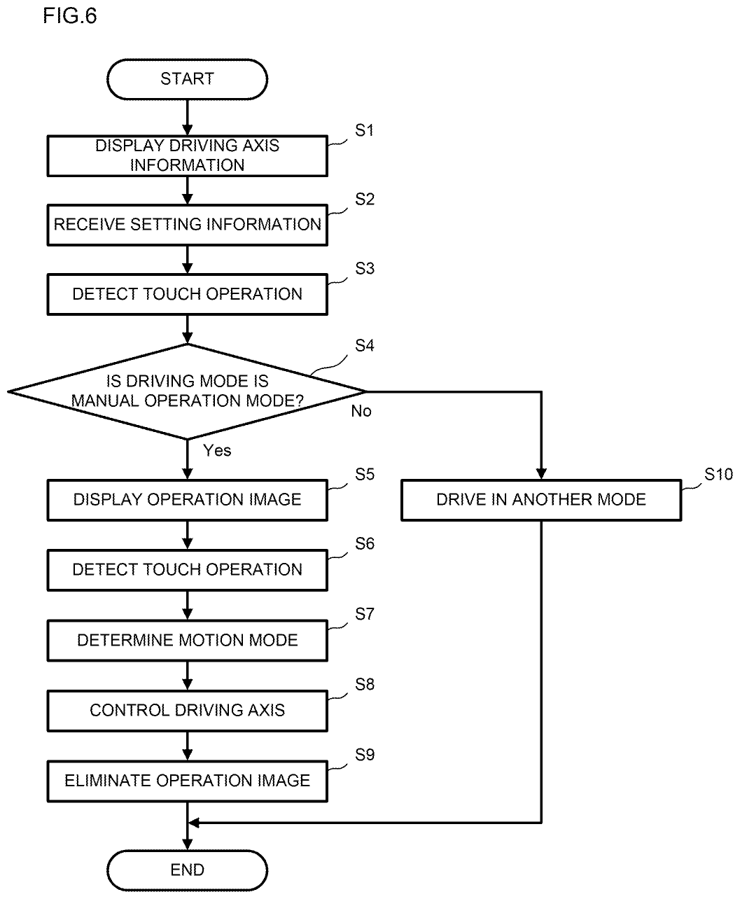

FIG. 6 is a flowchart illustrating an example of the flow of processing executed by the controller 2. In the controller 2, first, the image display unit 211 displays the driving axis information image 31 on the display screen 30 (step S1).

Next, the reception unit 213 receives setting of the operation mode (step S2).

Next, when the operator performs a touch operation on the display screen 30, the detection unit 212 detects the touch operation on the display screen 30 (step S3). At this time, for example, the detection unit 212 detects a touch operation on the driving axis information image 31.

Next, the decision unit 214 decides whether or not the set operation mode is the manual operation mode (step S4).

When the set operation mode is the manual operation mode (Yes in step S4), the image display unit 211 displays the operation image 32 (step S5).

Next, when the operator performs a touch operation on the operation image 32, the detection unit 212 detects the touch operation on the operation image 32 (step S6).

Next, the determination unit 215 determines the motion mode of the driving axis based on the operation on the operation image 32 (step S7).

Next, the control unit 216 controls the driving axis based on the motion mode determined by the determination unit 215 (step S8).

When the operation on the operation image 32 ends, the image display unit 211 eliminates the operation image 32 (step S9) and ends the process. For example, when there is no operation on the operation image 32 for a predetermined time, and the determination unit 215 determines to hide the operation image 32, the image display unit 211 eliminates the operation image 32.

When the set operation mode is another mode (No in step S4), the control unit 216 executes operation in the other mode (step S10) and ends the process. The other mode is, for example, the editing mode or the automatic operation mode.

As described above, the controller 2 includes the decision unit 214 that decides whether or not the set operation mode is the manual operation mode, the image display unit 211 that displays the operation image 32 corresponding to the manual operation mode on the display screen 30 when the decision unit 214 decides that the operation mode is the manual operation mode, the determination unit 215 that determines a motion mode of the driving axis based on an operation on the operation image 32, and the control unit 216 that controls the driving axis based on the motion mode determined by the determination unit 215.

Therefore, there is no need to install a dedicated switch for setting the operation mode of the driving axis on the control panel of controller 2, and the manufacturing costs of controller 2 can be reduced. In addition, the number of parts of the control panel can be reduced, assembly of the control panel is facilitated, and an assembly time of the control panel can be reduced. In addition, design changes of the display mode of the operation image 32, etc. can be facilitated. In this case, for example, the display mode can be designed according to a model of the industrial machine 1.

In addition, the controller 2 further includes the detection unit 212 that detects a touch operation on the display screen 30, and when the detection unit 212 detects a touch operation, the image display unit 211 displays the operation image 32 on the display screen 30. Therefore, the operation image 32 can be displayed on the display screen 30 only when manual operation is performed in the manual operation mode. In other words, it is possible to prevent the display screen 30 from becoming overloaded with information and improve visibility of the display screen 30.

In addition, the image display unit 211 further displays the driving axis information image 31 indicating driving axis information of the driving axis, and when the detection unit 212 detects a touch operation on the driving axis information image 31, the image display unit 211 displays the operation image 32 on the display screen 30. In addition, the image display unit 211 displays the operation image 32 adjacent to the driving axis information image 31. Therefore, the operator can visually recognize the driving axis information image 31 and the operation image 32 at the same time. Alternatively, the operator does not have to move a line of sight significantly between the driving axis information image 31 and the operation image 32. For this reason, it is possible to reduce the burden on the operator in an operation of manual operation.

In addition, the manual operation mode includes the jog feed mode, and when the manual operation mode is the jog feed mode, the image display unit 211 displays the operation image 32 including the axis movement button 323 for designating the movement direction of the driving axis and the jog feed override value on the display screen 30. Therefore, the override value and the movement direction of the jog feed can be designated by one touch. For this reason, the operator can easily perform a manual operation in the jog feed mode.

In addition, when an operation of eliminating the operation image 32 is performed, or when there is no operation on the operation image 32 for a predetermined time, the determination unit 215 determines to hide the operation image 32. Therefore, only necessary information can be displayed on the display screen 30. That is, it is possible to prevent the display screen 30 from becoming overloaded with information.

The above-described embodiment illustrates an example of the case where the operation mode is the jog feed mode. However, when the manual operation mode includes the incremental feed mode, and the manual operation mode is the incremental feed mode, the image display unit 211 may display an operation image including an axis movement button for designating the movement direction of the driving axis and the incremental feed magnification on the display screen 30.

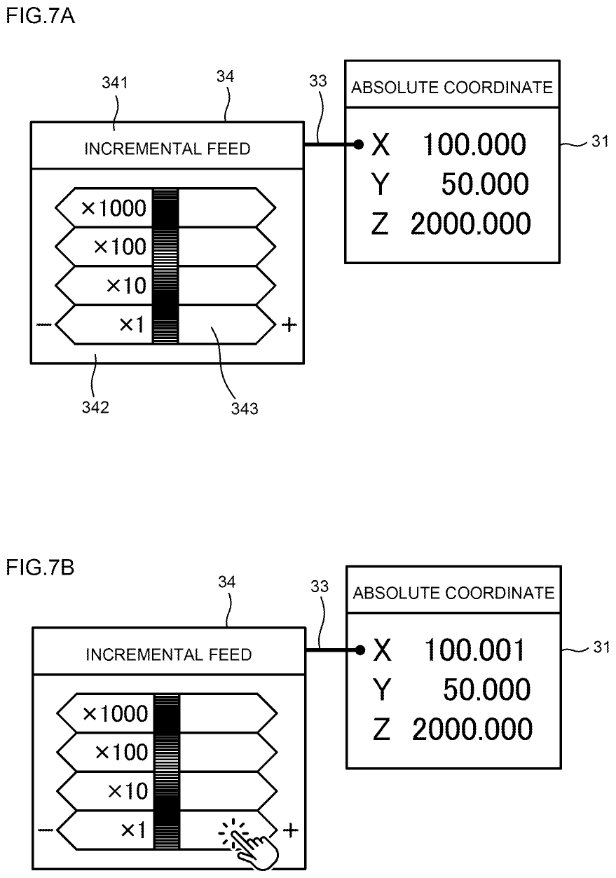

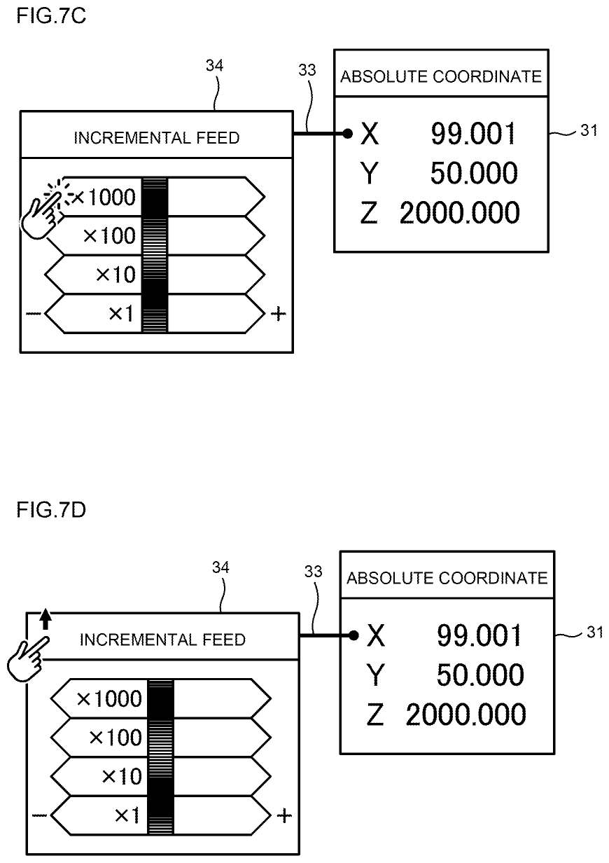

FIG. 7A is a diagram illustrating an example of the operation image and the axis specification image. FIG. 7A illustrates an operation image 34 and the axis specification image 33 displayed when the operation mode is set to the incremental feed mode.

The operation image 34 is displayed adjacent to the driving axis information image 31. The operation image 34 includes a setting mode display region 341 and an operation region 342.

In the setting mode display region 341, an image indicating in which mode among manual operation modes a manual operation is performed is displayed. In the example illustrated in FIG. 7A, the characters “incremental feed” indicating the incremental feed mode are displayed in the setting mode display region 341. In this way, the operator can recognize that a manual operation is performed in the incremental feed mode.

The operation region 342 is a region in which the axis movement buttons 343 each for performing an incremental feed operation are displayed. By the axis movement buttons 343, it is possible to designate the movement direction of the driving axis and the incremental feed magnification. The incremental feed magnification includes 1000 times, 100 times, 10 times, and one time, and 1000 times, 100 times, 10 times, and one time mean 1000μ, 100μ, 10μ, and 1μ, respectively.

For example, the axis movement buttons 343 include four elongated pentagonal images disposed on a right side of a rectangular image and four pentagonal images disposed on a left side of the rectangular image. The four elongated pentagonal images are displayed to vertically overlap each other, and the respective images are buttons for movement by 1000 times, 100 times, 10 times, and one time, respectively, in order from the top. Note that the axis movement buttons 343 on the right side of the rectangular image are buttons for moving the driving axis in the positive direction. The axis movement buttons 343 disposed on the left side of the rectangular image are buttons for moving the driving axis in the negative direction.

FIG. 7B is a diagram for describing an example of an operation on the operation image 34. FIG. 7B illustrates that an axis movement button 343 for moving the driving axis by one time in the positive direction among the axis movement buttons 343 on the right side is touched. In this case, the determination unit 215 determines to move the driving axis by one time in the positive direction of the X-axis.

FIG. 7C is a diagram for describing an example of an operation on the operation image 34. FIG. 7C illustrates that an axis movement button 343 for moving the driving axis by 1000 times in the negative direction among the axis movement buttons 343 on the left side is touched. In this case, the determination unit 215 determines to move the driving axis by 1000 times in the negative direction of the X-axis.

When an operation of eliminating the operation image 34 is performed, or when there is no operation on the operation image 34 for a predetermined time, the determination unit 215 determines to hide the operation image 34.

FIG. 7D is a diagram for describing an example of an operation on the operation image 34. An elimination operation is, for example, a flick operation. In this way, the image display unit 211 eliminates the operation image 34 together with the axis specification image 33 from the display screen 30. A direction of the flick operation may be any direction. In addition, when there is no operation on the operation image 34 for, for example, 20 seconds, the determination unit 215 determines to hide the operation image 34.

In the above-described embodiment, a plurality of axis movement buttons for moving the driving axis by 1000 times, 100 times, 10 times, and one time is displayed. However, the driving axis may be moved by a distance corresponding to one of 1000 times, 100 times, 10 times, and one time, depending on an operation way for one axis movement button.

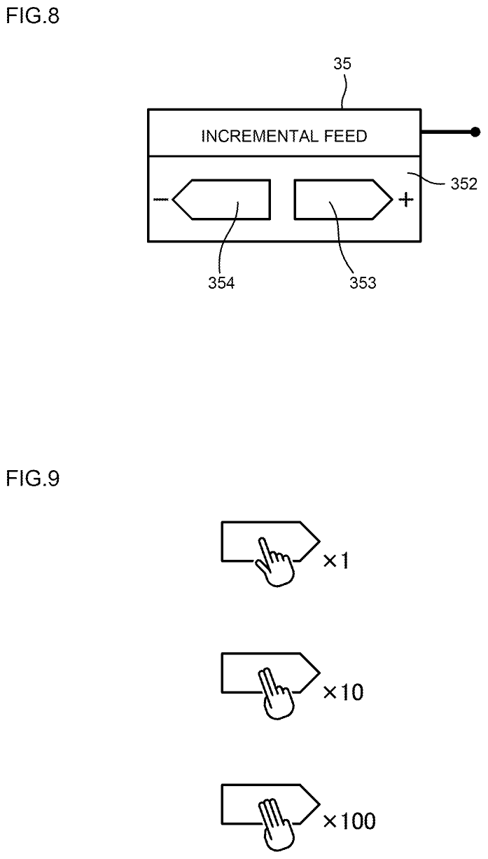

FIG. 8 is a diagram illustrating an example of an operation image. In an operation region 352 of an operation image 35, for example, an axis movement button 353 for moving the driving axis in the positive direction and an axis movement button 354 for moving the driving axis in the negative direction are displayed.

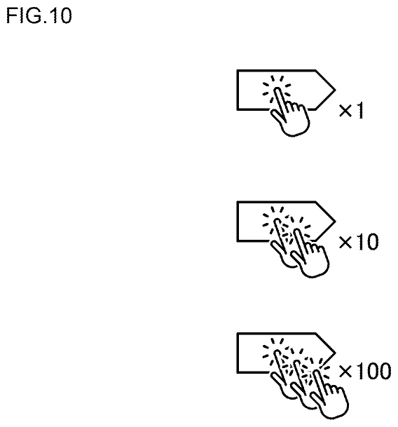

FIG. 9 is a diagram illustrating an example of an operation on the axis movement button 353. When the detection unit 212 detects that an operation of tapping one finger on an axis movement button 353 for moving the driving axis in the positive direction is performed, the determination unit 215 determines to move the driving axis by one time in the positive direction. Similarly, when the detection unit 212 detects that an operation of simultaneously tapping two fingers on the axis movement button 353 is performed, the determination unit 215 determines to move the driving axis by 10 times in the positive direction. Similarly, when the detection unit 212 detects that an operation of simultaneously tapping three fingers on the axis movement button 353 is performed, the determination unit 215 determines to move the driving axis by 100 times in the positive direction. In addition, although not illustrated, when the detection unit 212 detects that an operation of simultaneously tapping four fingers on the axis movement button 353 is performed, the determination unit 215 determines to move the driving axis by 1000 times in the positive direction. In this case, there is no need to display the axis movement button 353 corresponding to each incremental feed magnification. For this reason, a display region of the operation image 35 can be reduced. In addition, it is possible to prevent erroneous pressing of the axis movement button 353.

FIG. 10 is a diagram illustrating another example of the operation on the axis movement button 353. When the detection unit 212 detects that an operation of tapping on the axis movement button 353 for moving the driving axis in the positive direction is performed once, the determination unit 215 determines to move the driving axis by one time in the positive direction. Similarly, when the detection unit 212 detects that an operation of tapping on the axis movement button 353 is performed twice in succession, the determination unit 215 determines to move the driving axis by 10 times in the positive direction. Similarly, when the detection unit 212 detects that an operation of tapping on the axis movement button 353 is performed three times in succession, the determination unit 215 determines to move the driving axis by 100 times in the positive direction. In addition, although not illustrated, when the detection unit 212 detects that an operation of tapping on the axis movement button 353 is performed four times in succession, the determination unit 215 determines to move the driving axis by 1000 times in the positive direction. In this case, there is no need to display the axis movement button 353 corresponding to each incremental feed magnification. For this reason, a display region of the operation image 35 can be reduced. In addition, it is possible to prevent erroneous pressing of the axis movement button 353.

The disclosure is not limited to the above embodiments, and can be modified as appropriate without departing from the scope of the disclosure. In the disclosure, modification of any component of the embodiments or omission of any component of the embodiments is possible.

### EXPLANATIONS OF LETTERS OR NUMERALS

1 INDUSTRIAL MACHINE
2 CONTROLLER
21 OPERATION MODE SETTING SWITCH
201 CPU
202 BUS
203 ROM
204 RAM
205 NONVOLATILE MEMORY
206 INTERFACE
207 AXIS CONTROL CIRCUIT
208 SPINDLE CONTROL CIRCUIT
209 PLC
210 I/O UNIT
211 IMAGE DISPLAY UNIT
212 DETECTION UNIT
213 RECEPTION UNIT
214 DECISION UNIT
215 DETERMINATION UNIT
216 CONTROL UNIT
3 INPUT/OUTPUT DEVICE
30 DISPLAY SCREEN
31 DRIVING AXIS INFORMATION IMAGE
32 OPERATION IMAGE
321 SETTING MODE DISPLAY REGION
322 OPERATION REGION
323 AXIS MOVEMENT BUTTON
33 AXIS SPECIFICATION IMAGE
34 OPERATION IMAGE
341 SETTING MODE DISPLAY REGION
342 OPERATION REGION
343 AXIS MOVEMENT BUTTON
35 OPERATION IMAGE
352 OPERATION REGION
353 AXIS MOVEMENT BUTTON
354 AXIS MOVEMENT BUTTON
4 SERVO AMPLIFIER
5 SERVOMOTOR
6 SPINDLE AMPLIFIER
7 SPINDLE MOTOR
8 AUXILIARY DEVICE

1. A controller comprising:
a decision unit configured to decide whether or not a set operation mode is a manual operation mode;
an image display unit configured to display an operation image corresponding to the manual operation mode on a display screen when the decision unit decides that the operation mode is the manual operation mode;
a determination unit configured to determine a motion mode of a driving axis based on an operation on the operation image; and
a control unit configured to control the driving axis based on the motion mode determined by the determination unit.

2. The controller according to claim 1, further comprising a detection unit configured to detect a touch operation on the display screen,
wherein, when the detection unit detects the touch operation, the image display unit displays the operation image on the display screen.

3. The controller according to claim 2, wherein:
the image display unit further displays a driving axis information image indicating driving axis information of the driving axis; and
when the detection unit detects the touch operation on the driving axis information image, the image display unit displays the operation image on the display screen.

4. The controller according to claim 3, wherein the image display unit displays the operation image adjacent to the driving axis information image.

5. The controller according to claim 1, wherein:
the manual operation mode includes a jog feed mode; and
when the manual operation mode is the jog feed mode, the image display unit displays the operation image including an axis movement button for designating a movement direction of the driving axis and a jog feed override value on the display screen.

6. The controller according to claim 1, wherein:
the manual operation mode includes an incremental feed mode; and
when the manual operation mode is the incremental feed mode, the image display unit displays the operation image including a designation region for designating a movement direction of the driving axis and an incremental feed magnification on the display screen.

7. The controller according to claim 1, wherein:
the manual operation mode includes an incremental feed mode;
when the manual operation mode is the incremental feed mode, the image display unit displays the operation image including a designation region for designating a movement direction of the driving axis on the display screen; and
the determination unit determines an incremental feed magnification based on an operation way for the designation region.

8. The controller according to claim 1, wherein, when an operation of eliminating the operation image is performed, or when there is no operation on the operation image for a predetermined time, the determination unit determines to hide the operation image.
